(19) United States
(12) Patent Application Publication
(10) Pub. No.: US 2017/0004166 A1
(43) Pub. Date: Jan. 5, 2017

(54) UNSUPERVISED MULTISOURCE TEMPORAL ANOMALY DETECTION

(71) Applicant: International Business Machines Corporation, Armonk, NY (US)

(72) Inventors: Alain E. Biem, Mt. Kisco, NY (US); Jing Gao, Buffalo, NY (US); Deepak S. Turaga, E;msford, NY (US); Long H. Vu, White Plains, NY (US); Houping Xiao, Buffalo, NY (US)

(21) Appl. No.: 14/744,060

(22) Filed: Jun. 19, 2015

Related U.S. Application Data
(63) Continuation of application No. 14/674,435, filed on Mar. 31, 2015.

(51) Int. Cl. G06F 17/30

(52) U.S. Cl. CPC G06F 17/30371

(57) ABSTRACT

In one embodiment, a computer-implemented method includes observing one or more entities by way of two or more data sources. A plurality of detection scores are computed by one or more detectors. Each detection score corresponds to an entity of the one or more entities, a detector of the one or more detectors, and a time. The plurality of detection scores are compiled into two or more tensors, where each tensor corresponds to a data source of the two or more data sources. The two or more tensors are compared to one another, by a computer processor. An inconsistency score is calculated for each of the one or more entities, based on comparing the two or more tensors to one another.

### DOMESTIC PRIORITY

This application is a continuation of U.S. patent application Ser. No. 14/674,435, filed Mar. 31, 2015, the disclosure of which is incorporated by reference herein in its entirety.

### STATEMENT REGARDING FEDERALLY SPONSORED RESEARCH OR DEVELOPMENT

This invention was made with Government support under Contract No. H98230-14-D-0038 awarded by Department of Defense. The Government has certain rights to this invention.

### BACKGROUND

Various embodiments of this disclosure relate to temporal anomaly detection and, more particularly, to unsupervised multisource temporal anomaly detection.

A vast ocean of data is collected every day, and numerous applications require extraction of actionable insights from that data. One important task is to detect unusual or untrustworthy information because such information can indicate critical, unusual, or suspicious activities. Current solutions focus on characteristics of data, i.e., whether the data has certain features that have historically been characteristic of anomalies.

### SUMMARY

In one embodiment of this disclosure, a computer-implemented method includes observing one or more entities by way of two or more data sources. A plurality of detection scores are computed by one or more detectors. Each detection score corresponds to an entity of the one or more entities, a detector of the one or more detectors, and a time. The plurality of detection scores are compiled into two or more tensors, where each tensor corresponds to a data source of the two or more data sources. The two or more tensors are compared to one another, by a computer processor. An inconsistency score is calculated for each of the one or more entities, based on comparing the two or more tensors to one another.

In another embodiment, a system includes one or more computer processors configured to observe one or more entities by way of two or more data sources. The one or more computer processors are further configured to compute a plurality of detection scores by one or more detectors. Each detection score corresponds to an entity of the one or more entities, a detector of the one or more detectors, and a time. The one or more computer processors are further configured to compile the plurality of detection scores into two or more tensors, where each tensor corresponds to a data source of the two or more data sources. The one or more computer processors are further configured to compare the two or more tensors to one another. The one or more computer processors are further configured to calculate an inconsistency score for each of the one or more entities, based on comparing the two or more tensors to one another.

In yet another embodiment, a computer program product for detecting inconsistencies in an unsupervised manner includes a computer readable storage medium having program instructions embodied therewith. The program instructions are executable by a processor to cause the processor to perform a method. The method includes observing one or more entities by way of two or more data sources. Further according to the method, a plurality of detection scores are computed by one or more detectors. Each detection score corresponds to an entity of the one or more entities, a detector of the one or more detectors, and a time. The plurality of detection scores are compiled into two or more tensors, where each tensor corresponds to a data source of the two or more data sources. The two or more tensors are compared to one another. An inconsistency score is calculated for each of the one or more entities, based on comparing the two or more tensors to one another.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a diagram of a detection system, according to some embodiments of this disclosure;

FIG. 2 is a diagram of an embodiment of the detection system configured to detect inconsistencies in a communication network for cybersecurity;

FIG. 3 is a diagram of an embodiment of the detection system configured to detect inconsistencies in manufacturing process control;

FIG. 4 is a diagram of an embodiment of the detection system configured to detect inconsistencies in medical patient monitoring;

FIG. 5 is a diagram of a method for detecting inconsistent or anomalous data, according to some embodiments of this disclosure; and

FIG. 6 is a diagram of a computing device for implementing some or all aspects of the detection system, according to some embodiments of this disclosure.

### DETAILED DESCRIPTION

Various embodiments of this disclosure provide a mechanism to detect anomalous entities by combining and measuring inconsistency scores of entities across multiple time-varying data sources in an unsupervised manner. Specifically, a detection system according to this disclosure may run anomaly detection algorithms on the time-varying input data to obtain detection scores for monitored entities. Each data source connected to the entities may be represented as a tensor, representing detector versus entity versus time. The detection system may perform joint tensor factorization to extract the common subspaces shared across the data sources, resulting in a projection of the tensors onto the common subspaces, such that the multi-source information can be compared to detect inconsistencies. The detection system may quantify the degree of the inconsistencies to identify inconsistent data sources, entities, and detectors.

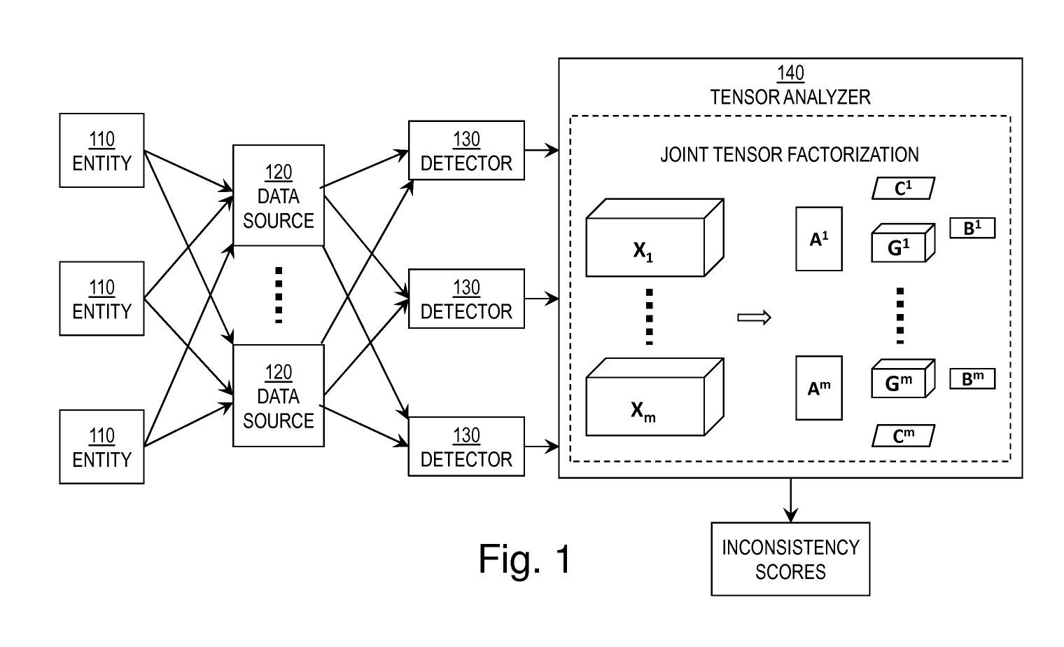

FIG. 1 is a diagram of a detection system 100, according to some embodiments of this disclosure. As shown, the detection system may apply to a set of one or more entities 110, and may include one or more data sources 120, one or more detectors 130, and a tensor analyzer 140.

Each entity 110 is a subject of the detection analysis being performed by the detection system 100. The entities 110 being considered may vary from one embodiment to another. As discussed later in this disclosure, some examples of entities 110 include network hosts, semiconductor wafers, and medical patients.

Each data source 120 may observe, or be a source of data based on, the entities 110. In some embodiments, multiple data sources 120 may be used, thus enabling data from the entities 110 to be analyzed based on various data sources 120, equivalent to various ways of viewing or monitoring the entities 110.

In general, a detector 130 is a mechanism (e.g., a computer program or a computing device) for applying a detection algorithm. In general, a detector 130 may apply a detection algorithm to input streams received from the one or more data sources 120, and may output one or more streams of detection scores. Specifically, in some embodiments, a detector 130 may output one data stream per data source. Each detection score may correspond to a particular data source 120, a particular entity 110, and a particular time, which may be point in time or a time window. Thus, a detection score may be a measurement, based on the detection algorithm used, of the particular entity 110 as viewed by the particular data source 120 at the particular time. Various detection algorithms may be used. For example, and not by way of limitation, the detection system 100 may use the local outlier factor algorithm, which is an existing anomaly detection algorithm.

The detection system 100 may compile the detection scores into tensors, with one tensor for each data source. A tensor is a set of data in three or more dimensions. As output by a detector 130, each tensor's three dimensions may correspond to an axis for each of entities 110, detectors 130, and time. More specifically, a first dimension may include a matrix of detector 130 versus time for each entity 110; a second dimension may include a matrix of entity 110 versus time for each detector 130; and a third dimension may include a matric of entity 110 versus time for each detector 130. Thus, each tensor may include a collection of detection scores for a data source 120 within a time window, the time window being the span of time represented by the detections scores within the tensor.

The tensor analyzer 140 may analyze the tensors resulting from the detection scores. This analysis may seek inconsistencies, or anomalies, through comparing the tensors to one another. Through this analysis, the detection system 100 may identify inconsistent data. Further, because each detection score represents an entity 110 and a detector 130, as well as a data source 120, the detection system 100 may identify which entities 110, detectors 130, and data sources 120 contribute to the inconsistencies. Thus, a user may know where to look when seeking the reason for this anomalous data.

More specifically, the tensor analyzer 140 may analyze the tensors by use of joint tensor factorization, which may identify the similarities and differences between the various tensors. Using joint tensor factorization, the tensor analyzer 140 may extract a latent tensor Gⁱ, which may represent the commonality between the tensors, and the remainder of each tensor may be represented by three matrices Aⁱ, Bⁱ, and Cⁱ for each tensor i. Across the various tensors, each Aⁱ may be similar to the other A, matrices; each Bⁱ matrix may be similar to the other Bⁱ matrices; and each Cⁱ matrix may be similar to the other C, matrices. The differences among the Aⁱ matrices, the Bⁱ matrices, and the Cⁱ matrices may be identified, and may be inconsistencies sought.

Joint tensor factorization is a technique to multilinearly project a tensor X^{s}, for s=1, 2; . . . ; M (i.e., a set of M tensors representing M data sources 120) in the high-dimensional space [symbol] ^{N×K×T} to the corresponding latent tensors G^{s} in the low-dimensional space [symbol] ^{C}^{_{N}}^{×K×C}^{_{T}}. In other words, in some embodiments:

[symbol]

^{s}= [symbol] ^{s}Π_{×d}U^{s,d}+ε^{s}.

In the above, G^{s}∈ [symbol] ^{C}^{_{N}}^{×K×C}^{_{T}} is the latent tensor. Each entry of G^{s} can be denoted as G_{uvw}, which represents the detection score at the u-th detector 130 and w-th time for the v-th entity 110. U^{s,d} is the d-th projection matrix, which constructs the multilinear mapping between the observed detection scores and the latent tensors. ε^{s}∈ [symbol] ^{M×K×T} is a residue tensor on the s-th data source 120. The residue tensor may represent the residue, or error, of its respective data source 120. It may be assumed that each entry of ε^{s} follows a Gaussian distribution N(0, σ²). Based on these observations, a probabilistic tensor factorization model is introduced to describe the distribution of the entry of residue tensor, as follows:

Pr(ε^{s} [symbol] ^{s}, [symbol] ^{s},U^{s,d})∝exp(−∥ [symbol] ^{s}− [symbol] ^{s}Π_{×d}U^{s,d}∥_{F}²).

In this disclosure, Θ={G^{s}, U^{s,d}|s==1, 2, . . . , M; d=1, 2, 3} denotes a set of parameters, where the parameters are estimated from the observed tensor data. The task of joint tensor factorization may be formulated as an optimization problem.

Regarding a three-dimensional scenario (e.g., entities 110 versus detectors 130 versus time) in which anomaly detection is sought, as discussed above, detection scores may be collected from M data sources 120. It will be understood that, while this disclosure focuses on three-dimensional tensors for illustrative purposes, extensions to higher dimensions are straight forward. The log-likelihood of parameter set Θ, given the M observed tensors, may be expressed as follows:

$${L}_{Λ} ( Θ ) ∝ \frac{1}{M} log {Π}_{s = 1}^{M} Pr ( {ɛ}^{s} \vert {X}^{s} , Θ ) \\ ∝ - \frac{1}{M} {\sum }_{s = 1}^{M} {‖ {X}^{s} - {G}^{s} {Π}_{\times d} {U}^{s , d} ‖}_{F}^{2}$$

A consistent entity 110 may be an entity 110 whose behavior is consistent across different data sources 120, each represented by a tensor. Thus, it is assumed that the detectors 130 will provide similar results across the various tensors. To incorporate this observation, model parameters may be estimated by minimizing a penalized log-likelihood function, which may be defined as:

$${L}_{Λ} ( Θ ) ∝ - \frac{1}{2} L ( Θ ) + {\sum }_{l = 1}^{3} {\sum }_{s = 1}^{M} ( \frac{{λ}_{l}}{2} {‖ {U}^{s , l} - {U}^{* , l} ‖}_{F}^{2} )$$

In the above,

$${U}^{* , l} = \frac{1}{M} {Σ}_{s = 1}^{M} {U}^{s , l} ,$$

for 1=1, 2, 3, and Λ=[λ₁, λ₂, λ₃] is a regularizer parameter vector. The first term in the above,

$$- \frac{1}{2} L ( Θ ) ,$$

represents the negative log-likelihood, while the second term is a regularizer, which may have a two-fold meaning and purpose: (1) behavior of the clusters of detectors 130 and times should be consistent across the data sources 120, and (2) it is adopted to prevent overfitting. Generally, overfitting occurs when an algorithm works well in the training data but has bad performance on incoming data. The regularizer may be provided here to avoid this. More specifically, L_{Λ}(U^{s,l}|Θ) is the objective function with respect to U^{s,l}, and L_{Λ}(G^{s}|Θ) is the objective functions in terms of G^{s}.

Following, an algorithm is proposed to iteratively optimize L_{Λ}(U^{s,l}|Θ) and L_{Λ}(G^{s}|Θ) by constructing corresponding surrogate functions to decouple the parameters.

Herein, the parameter set on the n-th iteration is denoted by Θₙ={Gₙ^{s},Uₙ^{s,l}|1≦s≦M, 1≦l≦3}. Surrogate functions Q₁(U^{s,l}|Θ; Θₙ) and Q₂(G^{s}|Θ; Θₙ) may be constructed as follows, and it will be shown that they are tight upper bounds of L_{Λ}(U^{s,l}|Θ) and L_{Λ}(G^{s}|Θ) with respect to U^{s,l} and G^{s} respectively:

$${Q}_{1} ( {U}^{s , l} \vert Θ ; {Θ}_{n} ) = {Σ}_{s = 1}^{M} [ {Σ}_{i , j} \frac{{[ {U}_{n}^{s , l} ( {{A}_{l}^{s} ( {A}_{l}^{s} )}^{T} + {λ}_{l} {I}_{l} ) ]}_{ij} {( {U}_{ij}^{s , l} )}^{2}}{2 {{U}_{n}^{s , l}}_{ij}} - 2 {Σ}_{i , j} {{{U}_{n}^{s , l}}_{ij} [ {{X}_{( l )}^{s} ( {A}_{l}^{s} )}^{T} ]}_{ij} ( 1 + log \frac{{U}_{ij}^{s , l}}{{{U}_{n}^{s , l}}_{ij}} ) - 2 {λ}_{l} {Σ}_{i , j} {{U}_{n}^{s , l}}_{ij} {U}_{ij}^{s , l} ( 1 + log \frac{{U}_{ij}^{s , l}}{{{U}_{n}^{s , l}}_{ij}} ) ] \\ {Q}_{2} ( {𝒢}^{s} \vert Θ ; {Θ}_{n} ) = {Σ}_{s = 1}^{M} [ {Σ}_{l} \frac{{[ vec ( {𝒢}_{n}^{s} ) {{U}^{s} ( {U}^{s} )}^{T} ]}_{l} {vec ( {𝒢}^{s} )}_{l}^{2}}{2 vec ( {𝒢}^{s} )} - 2 {Σ}_{l} {vec ( {𝒢}_{n}^{s} )}_{l} {vec ( {X}^{s} )}_{l} {( {U}^{s} )}^{T} ( 1 + log \frac{{vec ( {𝒢}^{s} )}_{l}}{{vec ( {𝒢}_{n}^{s} )}_{l}} ) ] \vert$$

In the above, the terms X₍ₗ₎^{s} and G₍ₗ₎^{s} are matrices unfolding X^{s} and G^{s} on l-th mode; vec( ) is a vectorization operation of a tensor as defined above; Aₗ^{s}=G₍ₗ₎^{s}(U^{s,m} [symbol] U^{s,n})^{T} in which m, n≠l and m>n; and U^{s}=U^{s,3} [symbol] U^{s,2} [symbol] U^{s,1}. Additionally, Iₗ is the identity matrix whose dimension is the same as the l-th dimension of the original tensor.

Q₁(U^{s,l}|Θ; Θₙ) and Q₂(G^{s}|Θ; Θₙ) enjoy the following desired properties:

$$\{ \begin{matrix}{Q}_{1} ( {U}^{s , l} \vert Θ ; {Θ}_{n} ) \geq {L}_{Λ} ( {U}^{s , l} \vert Θ ) , & ∀ Θ , {Θ}_{n} \\ {Q}_{1} ( {U}^{s , l} \vert Θ ; {Θ}_{n} ) = {L}_{Λ} ( {U}^{s , l} \vert {Θ}_{n} ) , & ∀ {Θ}_{n}\end{matrix} \\ and \\ \{ \begin{matrix}{Q}_{2} ( {G}^{s} \vert Θ ; {Θ}_{n} ) \geq {L}_{Λ} ( {G}^{s} \vert Θ ) , & ∀ Θ , {Θ}_{n} \\ {Q}_{2} ( {G}^{s} \vert Θ ; {Θ}_{n} ) = {L}_{Λ} ( {G}^{s} \vert {Θ}_{n} ) , & ∀ {Θ}_{n}\end{matrix}$$

It may be assumed that the solutions Uₙ₊₁^{s,l} and Gₙ₊₁^{s,l} are obtained from the optimization problems min_{U}_{^{s,l}}_{∈Θ}Q₁(U^{s,l}|Θ; Θn) and min_{G}_{^{s}}_{∈Θ}Q₂(G^{s}|Θ; Θn). Following the above properties, it may be deduced that L_{Λ}(U^{s,l}|Θₙ)≧L_{Λ}(U^{s,l}|Θₙ₊₁) and L_{Λ}(G^{s}|Θₙ)≧L_{Λ}(G^{s}|Θₙ₊₁), which means that minimizing Q₁(U^{s,l}|Θ; Θₙ) and Q₂(G^{s}|Θ; Θₙ) at each iteration, in some embodiments, guarantees that L_{Λ}(U^{s,l}|Θₙ) and L_{Λ}(G^{s}|Θₙ) will monotonically decrease with respect to U^{s,l}∈Θ and G^{s}∈Θ respectively.

Owing to the desired property of surrogate functions built above, the closed form solution of U^{s,l} and G^{s} may be derived by solving the optimization problems min^{U}^{_{s,l}}_{∈Θ}Q₁(U^{s,l}|Θ; Θn) and min_{G}_{^{s}}_{∈Θ}Q₂(G^{s}|Θ; Θn), respectively. By deriving the derivatives of Q₁(U^{s,l}|Θ; Θₙ) and Q₂(G^{s}|Θ; Θₙ) with respect to U^{s,l} and G^{s} respectively and setting them equal to zero, their update rules may be obtained as follows:

$$\begin{matrix}{U}_{ij}^{s , l} ← {U}_{ij}^{{′}_{s , l}} \sqrt{\frac{{[ {X}_{( l )}^{s} {A}_{l}^{s} + {λ}_{l} {U}^{* , l} ]}_{ij}}{{[ {U}^{{′}_{s , l}} ( {{A}_{l}^{s} ( {A}_{l}^{s} )}^{T} + {λ}_{l} {I}_{l} ) ]}_{ij}}} & ( Equation 1 ) \\ {vec ( {𝒢}^{s} )}_{k} ← {vec ( {𝒢}^{′s} )}_{k} \sqrt{\frac{{[ {U}^{s} vec ( {χ}^{s} ) ]}_{k}}{{[ {U}^{s} {U}^{sT} vec ( {𝒢}^{{′}_{s}} ) ]}_{k}}} & ( Equation 2 )\end{matrix}$$

Instead of updating the latent tensors, an update rule may be used for their corresponding vector, obtained from the vectorization operation vec( ). In some embodiments, one more mapping is necessary from the updated vector form, vec(G^{s}), to the latent tensor.

In some embodiments, all of the M data sources 120 may describe the behavior of the entities 110. Thus, it may be expected that the M data sources 120, and M resulting tensors, will achieve a similar projection for each host. The joint tensor factorization model may map the observed tensor X^{s} into an unobserved latent tensor G^{s}. Because the projection matrices are constrained to be similar, the differences across views appear more in G^{s}. Herein, G* denotes the average latent tensor, which represents a common subspace. Some embodiments of the detection system 100 may calculate the similarity between G^{s} and G* and, for each entity 110, may define an inconsistency score as the variance of the similarity over the latent subspace represented by the latent tensor G^{s}. In some embodiments, a higher inconsistency score means the variance of similarity between latent subspaces is bigger, which represents a bigger difference across the data sources 120.

The tensors G^{s} and G* may be obtained by joint tensor factorization. G^{s} and G* may be three dimensional tensors, where one of those three dimensions is an entity dimension. For the j-th entity 110, the detection system 100 may slice G^{s} and G* on this entity dimension to obtain two matrices. The detection system 100 may calculate the cosine similarity between these two matrices. Consequently, the detection system 100 may obtain a vector of cosine similarity across the data sources 120. The inconsistency score of the j-th entity 110 may be defined as the variance of this cosine similarity vector across the latent tensors G^{s}. Because the variance measures how far a set of numbers is spread out, the higher the variance, the more inconsistent the entity and also the higher the inconsistency score. One of skill in the art will understand that an inconsistency score may be calculated for a detector 130 in an analogous manner to that used to calculate an inconsistency score for an entity 110.

Because initialization plays a role in the above algorithm, the detection system 100 may set an appropriate starting point for the above optimization. The original observed data for the k-th entity 110 is denoted by Xₖ∈ [symbol] ^{N×T} herein. The detection system 100 may apply a clustering algorithm, such as K-means clustering, to Xₖ and may achieve a final clustering index by majority vote. Thus:

$${U}_{ij}^{s , l} = {arg}_{x \leq \{ 0 , 1 \}} {max}_{k = 1 , … , K} \{ \# ( {u}_{ij}^{k , l} = x ) \} \qquad ( Equation 3 )$$

In the above, if the i-th object belongs to the j-th cluster, then uᵢⱼ^{k,l}=1; otherwise, uᵢⱼ^{k,l} is zero. More specifically, u^{k,l}∈ [symbol] ^{N×C}^{_{N}} represents the result of the clustering algorithm on Xₖ, treating its columns as attributes; u^{k,2}∈ [symbol] ^{K×K} is an identity matrix; and u^{k,3}∈ [symbol] ^{T×C}^{_{T}} represents the result of the clustering algorithm on Xₖ, treating its rows as attributes.

In summary, a tensor X^{s}, being a set of M tensors such that s=[1, M], may be factorized in a method representable by the following pseudocode, which, after proper initialization, iterates between updating U^{s,l} and G^{s} (being a set of M tensors such that s=[1, M]) until the objective function converges.

In the below pseudocode, Var( ) is a variance operator, such as in MatLab®. Additionally, C_{N}, C_{K}, and Λ=[λ₁, λ₂, λ₃] are parameters tuned to find the historical best performance, or acceptable performance, of the above algorithm. Their values depend on the real data set. Specifically, the values of C_{N} and C_{K} may each be determined through clustering, such as k-means clustering, on the data for each data source 120. The clustering may result in a quantity of groups for each data source 120, and the smallest quantity of groups across sources may be chosen as initial values of C_{N} and C_{K}. While tuning, the other quantities of groups may be also be tried for the values of C_{N} and C_{K}. For the regularized parameters Λ=[λ₁, λ₂, λ₃], the values used may begin at 0.1 and increase by steps of 0.1 to a maximum values of 2, for example.

Input: X^{s}, C_{N}, C_{K}, and Λ=[λ₁, λ₂, λ₃]
Output: U^{s,l}, G^{s}, and inconsistency scores list I

```
begin
  /* Initialization */
  initialize U^{s,l} according to Equation 3;
  while not yet converged do
    /* Updating parameters */
    for s = 1 to M do /* where M is the number of data sources */
      for l = 1 to 3 do
        update U^{s,l} according to Equation 1;
      update G^{s} according to Equation 2;
  /* Calculation of inconsistency score list I */
  ${G}^{*} = \frac{1}{M} {\sum }_{s = 1}^{M} {G}^{s} ;$
  for k = 1 to K do /* where K is the number of entities */
    for s = 1 to M do
      S(s) is the cosine similarity between G^{s} and G*;
    I(k) = Var(S)
```

The detection system 100 may use the inconsistency scores to identify which aspects (e.g., which entities 110, which detectors 130, which data sources 120) of the detection system 100 contribute to an inconsistency. More specifically, an entity 110 or detector 130 with a high inconsistency score may be deemed to contribute to the inconsistency. A user of the detection system 100 may thus be aware of which entities 110 and detectors 130 to examine to trouble shoot the inconsistency.

Some embodiments of the detection system 100 may be used in various applications. For example, and not by way of limitation, the detection system 100 may be used for communication network anomaly detection in cybersecurity, manufacturing process control, and medical patient monitoring.

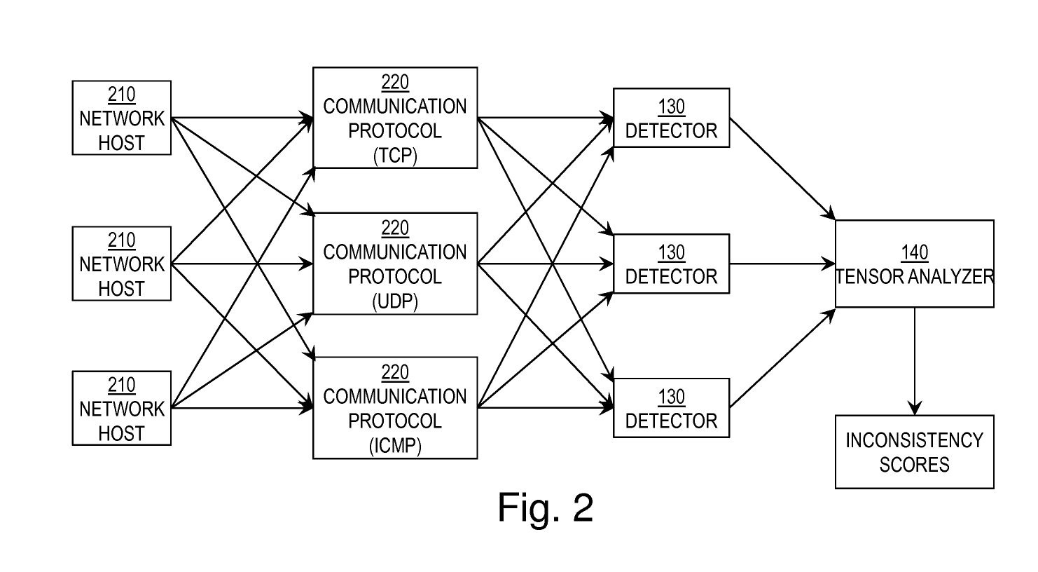

FIG. 2 is a diagram of an embodiment of the detection system 100 configured to detect inconsistencies in a communication network for cybersecurity. In this embodiment, the detection system 100 may run anomaly detection algorithms on time-varying network data sources, such as Netflow, Domain Name System (DNS), and firewalls. The detection system 100 may combine detection scores to identify network hosts whose network metrics are inconsistent across sources and time, and to identify data sources and detectors that contribute to the inconsistency scores of the most inconsistent hosts. As shown, the entities 110 used in this embodiment are network hosts 210 and the data sources 120 are communication protocols 220, including Transmission Control Protocol (TCP), User Datagram Protocol (UDP), and Internet Control Message Protocol (ICMP). In this embodiment, the each network host 210 may transmit data over each of the communication protocols 220, and the detectors 130 may analyze the resulting data. The tensor analyzer 140 may be configured to analyze the resulting tensors to identify inconsistent detectors 130 and network hosts 210. Based on identified inconsistencies, a user may decide to manage the communication protocols 220, detectors 130, and network hosts 210 to attempt to address the problem leading to the inconsistencies.

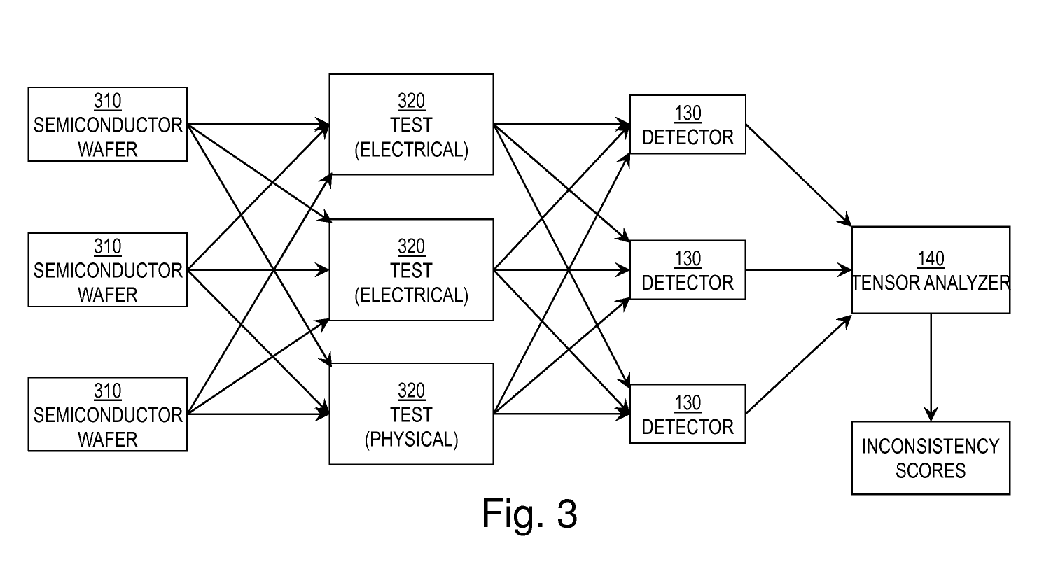

FIG. 3 is a diagram of an embodiment of the detection system 100 configured to detect inconsistencies in manufacturing process control. In this embodiment, the detection system 100 may run anomaly detection algorithms on time-varying data of inline measurement performed on semiconductor chips 310. Various tests 320 may be performed on the inline measurement data, and these tests 320 may behave as the data sources 120. In this example, the tests 320 performed may include an electrical test, a functional test, and a physical test. The detectors 130 may apply their respective detection algorithms to the outputs of these tests 320, and the data generated by the detectors 130 may thus be arranged into tensors, with each tensor corresponding to a test 320. The tensor analyzer 140 may be configured to analyze the tensors to identify inconsistent detectors 130 and semiconductor chips 310. Based on identified inconsistencies, a user may decide to manage the tests 320, detectors 130, and semiconductor chips 310 to attempt to address the problem leading to the inconsistencies.

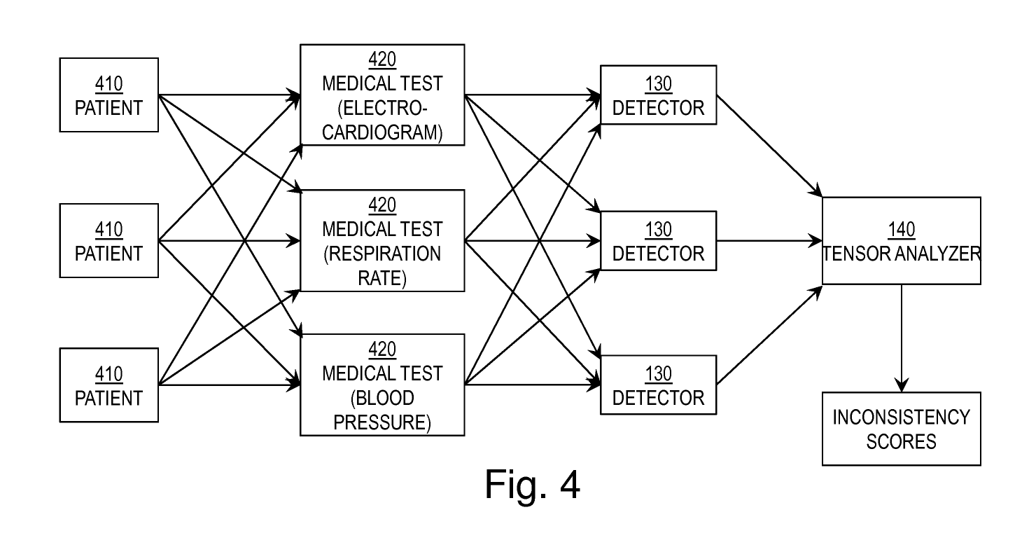

FIG. 4 is a diagram of an embodiment of the detection system 100 that detects inconsistencies in medical patient monitoring. In this embodiment, the detection system 100 may run anomaly detection algorithms on time-varying monitoring data of monitoring devices connected to medical patients 410. Medical tests 420 may be performed on the monitoring data, and these medical tests 420 may behave as the data sources 120. In this example, the medical tests 420 performed may include an electrocardiogram test, a respiration rate test, and a blood pressure test. The detectors 130 may apply their respective detection algorithms to the outputs of these medical tests 420, and the data generated by the detectors 130 may thus be arranged into tensors. Each tensor may correspond to one of the medical tests 420. The tensor analyzer 140 may be configured to analyze the tensors to identify inconsistent detectors 130 and patients 410. Based on identified inconsistencies, a user may decide to manage the medical test 420, detectors 130, and patients 410 to attempt to address the problem leading to the inconsistency.

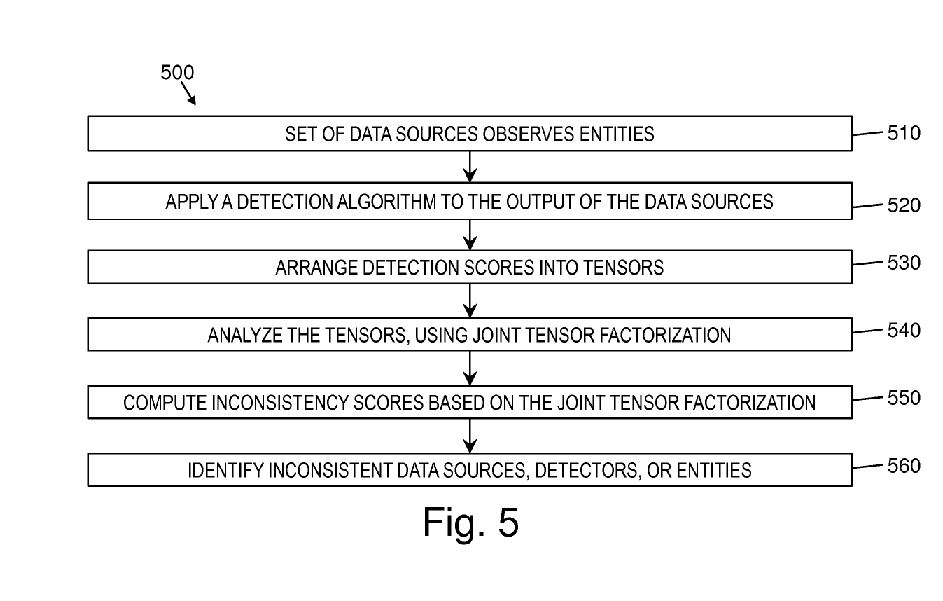

FIG. 5 is a diagram of a method 500 for detecting inconsistent or anomalous data, according to some embodiments of this disclosure. As shown, at block 510, a set of one or more data sources 120 may observe one or more entities 110. At block 520, one or more detectors 130 may each apply a detection algorithm to the output of the data sources 120. At block 530, detection scores output by the detectors may be arranged into tensors, with each tensor corresponding to a data source 120. At block 540, the tensor analyzer 140 may analyze the tensors, using joint tensor factorization. At block 550, the tensor analyzer 140 may compute inconsistency scores for the data sources 120, detectors 130, and entities 110. At block 560, inconsistent data sources 120, detectors 130, or entities 110 may be identified based on the inconsistency scores.

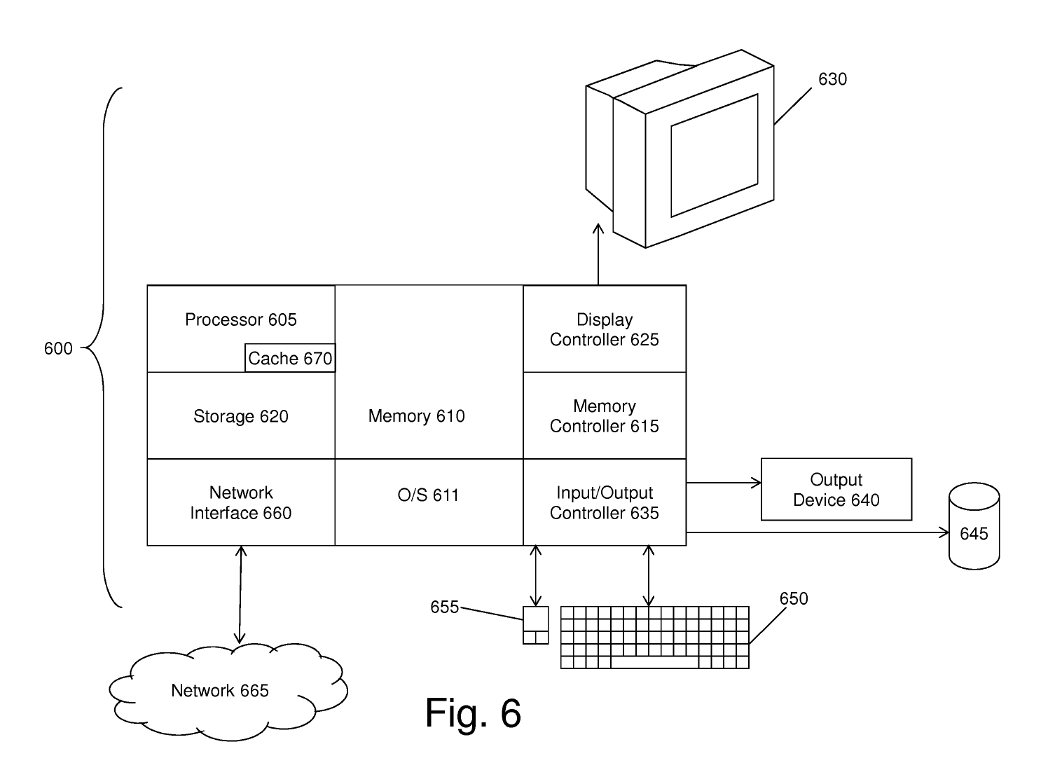

FIG. 6 illustrates a diagram of a computer system 600 for use in implementing a detection system or method according to some embodiments. The detection systems and methods described herein may be implemented in hardware, software (e.g., firmware), or a combination thereof. In an exemplary embodiment, the methods described may be implemented, at least in part, in hardware and may be part of the microprocessor of a special or general-purpose computer system 600, such as a personal computer, workstation, minicomputer, or mainframe computer.

In an exemplary embodiment, as shown in FIG. 6, the computer system 600 includes a processor 605, memory 610 coupled to a memory controller 615, and one or more input devices 645 and/or output devices 640, such as peripherals, that are communicatively coupled via a local I/O controller 635. These devices 640 and 645 may include, for example, a printer, a scanner, a microphone, and the like. A conventional keyboard 650 and mouse 655 may be coupled to the I/O controller 635. The I/O controller 635 may be, for example, one or more buses or other wired or wireless connections, as are known in the art. The I/O controller 635 may have additional elements, which are omitted for simplicity, such as controllers, buffers (caches), drivers, repeaters, and receivers, to enable communications.

The I/O devices 640, 645 may further include devices that communicate both inputs and outputs, for instance disk and tape storage, a network interface card (NIC) or modulator/demodulator (for accessing other files, devices, systems, or a network), a radio frequency (RF) or other transceiver, a telephonic interface, a bridge, a router, and the like.

The processor 605 is a hardware device for executing hardware instructions or software, particularly those stored in memory 610. The processor 605 may be a custom made or commercially available processor, a central processing unit (CPU), an auxiliary processor among several processors associated with the computer system 600, a semiconductor based microprocessor (in the form of a microchip or chip set), a macroprocessor, or other device for executing instructions. The processor 605 includes a cache 670, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 670 may be organized as a hierarchy of more cache levels (L1, L2, etc.).

The memory 610 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 610 may incorporate electronic, magnetic, optical, or other types of storage media. Note that the memory 610 may have a distributed architecture, where various components are situated remote from one another but may be accessed by the processor 605.

The instructions in memory 610 may include one or more separate programs, each of which comprises an ordered listing of executable instructions for implementing logical functions. In the example of FIG. 6, the instructions in the memory 610 include a suitable operating system (OS) 611. The operating system 611 essentially may control the execution of other computer programs and provides scheduling, input-output control, file and data management, memory management, and communication control and related services.

Additional data, including, for example, instructions for the processor 605 or other retrievable information, may be stored in storage 620, which may be a storage device such as a hard disk drive or solid state drive. The stored instructions in memory 610 or in storage 620 may include those enabling the processor to execute one or more aspects of the detection systems and methods of this disclosure.

The computer system 600 may further include a display controller 625 coupled to a display 630. In an exemplary embodiment, the computer system 600 may further include a network interface 660 for coupling to a network 665. The network 665 may be an IP-based network for communication between the computer system 600 and an external server, client and the like via a broadband connection. The network 665 transmits and receives data between the computer system 600 and external systems. In an exemplary embodiment, the network 665 may be a managed IP network administered by a service provider. The network 665 may be implemented in a wireless fashion, e.g., using wireless protocols and technologies, such as WiFi, WiMax, etc. The network 665 may also be a packet-switched network such as a local area network, wide area network, metropolitan area network, the Internet, or other similar type of network environment. The network 665 may be a fixed wireless network, a wireless local area network (LAN), a wireless wide area network (WAN) a personal area network (PAN), a virtual private network (VPN), intranet or other suitable network system and may include equipment for receiving and transmitting signals.

Detection systems and methods according to this disclosure may be embodied, in whole or in part, in computer program products or in computer systems 600, such as that illustrated in FIG. 6.

Technical effects and benefits of some embodiments include the ability to identify anomalous data in an unsupervised manner. With some embodiments of the detection system 100, anomalous data may be identified, along with contributing data sources 120, detectors 130, and entities 110. As a result, the inconsistencies can be efficiently addressed.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
observing one or more entities by way of two or more data sources;
computing a plurality of detection scores by one or more detectors, wherein each detection score corresponds to an entity of the one or more entities, a detector of the one or more detectors, and a time;
compiling the plurality of detection scores into two or more tensors, wherein each tensor corresponds to a data source of the two or more data sources;
comparing, by a computer processor, the two or more tensors to one another; and
calculating an inconsistency score for each of the one or more entities, based on the comparing the two or more tensors to one another.

2. The method of claim 1, wherein the comparing the two or more tensors to one another comprises performing joint tensor factorization.

3. The method of claim 2, wherein the performing joint tensor factorization comprises:
projecting the one or more tensors onto a common subspace; and
identifying differences between a remainder of the one or more tensors outside the common subspace.

4. The method of claim 1, wherein each tensor of the two or more tensors comprises a first dimension corresponding to the one or more entities, a second dimension corresponding to the one or more detectors, and a third dimension corresponding to time.

5. The method of claim 1, further comprising calculating an inconsistency score for each of the one or more detectors, based on the comparing the two or more tensors to one another.

6. The method of claim 1, further comprising calculating an inconsistency score for each of the one or more data sources, based on the comparing the two or more tensors to one another.
